(19) United States
(12) Patent Application Publication
(10) Pub. No.: US 2008/0288654 A1
(43) Pub. Date: Nov. 20, 2008

(54) Node and method to provide and keep real-time up-to-date data in a distributed hash table

(75) Inventors: Marcin Wieslaw Matuszewski, Espoo (FI); Miguel Angel Garcia-Martin, Helsinki (FI)

Correspondence Address: HARRINGTON & SMITH, PC, 4 RESEARCH DRIVE, SHELTON, CT, 06484-6212, US

(73) Assignees: Nokia Corporation; Nokia Siemens Networks Oy

(21) Appl. No.: 11/798,942

(22) Filed: May 17, 2007

(51) Int. Cl. G06F 15/173

(52) U.S. Cl. 709/238

(57) ABSTRACT

A node and method are provided that create a finger table at the node, subscribe to changes in a network address of at least one other node included in the finger table, receive at least one notification including an identifier and a network address of the at least one other node, and update the finger table with a new network address of the at least one other node received in the at least one notification. The node and method also create a reverse finger table at a node, receive subscriptions to changes in a network address of the node from another node, store the network address of the other node in the reverse finger table, and when the network address of the node changes, send a notification of a new network address from the node to the other node in the reverse finger table.

### BACKGROUND OF THE INVENTION

1. Field of the Invention

The present invention relates to a node and method providing and maintaining real-time up-to-date data in a distributed hash table network architecture, in particular, the present invention provides a node and method for configuring, providing, and maintaining real-time up-to-date peer identification and Internet protocol address mapping information in peer nodes of a distributed hash table network architecture.

2. Description of the Related Art

One family of peer-to-peer overlay protocols is referred to as Distributed Hash Tables (DHT), which provides routing and object location functionality for peer-to-peer applications. The DHT is a structured overlay network architecture that provides a flexible approach for connecting multiple nodes in a communications network. A DHT protocol provides an efficient and easily implemented substrate, referred to as a structured overlay, for building scalable and self-organizing distributed applications. A structured overlay maps keys that identify application data to overlay nodes that are responsible for managing that data. At the most basic level, the DHT allows a group of distributed hosts to collectively manage a mapping from keys to data values, without any fixed hierarchy, and with very little human assistance. This building block can then be used to ease the implementation of a diverse variety of peer-to-peer applications such as file sharing services, DNS replacements, web caches, etc.

The DHT allows for locating any piece of data stored in the overlay network using a limited number of messages, typically log(N) messages. The nodes that form an overlay network are called peers. Each peer gets a unique peer identification (ID), sometimes also called node ID, when it joins the DHT. The DHT is typically organized in a ring topology. A hash table's keyspace may be circular, and peer IDs may be 128-bit unsigned integers representing position in the circular keyspace. Typically, peer IDs are created by hashing the peer IP address. Therefore, if the IP address of the peer changes, the peer ID changes as well. In the context of the present document “IP Address” may include in addition to, or instead of, an IP address also transmission control protocol (TCP) and/or user datagram protocol (UDP) port numbers.

### SUMMARY OF THE INVENTION

In accordance with an embodiment of the present invention, there is provided a node including a table having a list of node identifiers of neighboring nodes and corresponding addresses, wherein the list of node identifiers and the addresses are configured independently from each other to update a change in at least one of the addresses associated with at least one of the neighboring nodes.

In accordance with an embodiment of the present invention, there is provided a node configured to create a finger table, configured to subscribe to changes in a network address of at least one other node included in the finger table, and configured to receive at least one notification including an identifier and a network address of the at least one other node. The node is also configured to update the finger table with a new network address of the at least one other node received in the at least one notification.

In accordance with an embodiment of the present invention, there is provided a node configured to create a reverse finger table, configured to receive subscriptions to changes in a network address of the node from at least one other node, and configured to store the network address of the at least one other node in the reverse finger table. The node is also configured to send a notification of a new network address from the node to the at least one other node in the reverse finger table when the network address of the node changes.

In accordance with an embodiment of the present invention, there is provided a node configured to create a neighbor table, configured to learn network identifiers and/or network addresses of neighbor nodes, and configured to store the network identifiers and/or network addresses of neighbor nodes in the neighbor table. The node is also configured to send a notification of a new network address to the at least one other neighbor node in the neighbor table when the network address of the node changes.

In accordance with an embodiment of the present invention, there is provided a node configured to create a neighbor table, configured to learn network identifiers and/or network addresses of neighbor nodes, and configured to store the network identifiers and/or the network addresses of neighbor nodes in the neighbor table. The node is also configured to receive a notification of a new network address from the node at the at least one other neighbor node stored in the neighbor table, and configured to update the neighbor table of the at least one other neighbor node with the new network address from the node.

In accordance with an embodiment of the present invention, there is provided a node including means for creating a finger table, means for subscribing to changes in a network address of at least one other node included in the finger table, and means for receiving at least one notification including an identifier and a network address of the at least one other node. The node also includes means for updating the finger table with a new network address of the at least one other node received in the at least one notification.

In accordance with an embodiment of the present invention, there is provided a node, including means for creating a reverse finger table, means for receiving subscriptions to changes in a network address of the node from at least one other node, and means for storing the network address of the at least one other node in the reverse finger table. The node also includes means for sending a notification of a new network address from the node to the at least one other node in the reverse finger table when the network address of the node changes.

In accordance with an embodiment of the present invention, there is provided a node, including means for creating a neighbor table, means for learning network identifiers and/or network addresses of neighbor nodes, and means for storing the network identifiers and/or network addresses of neighbor nodes in the neighbor table. The node also includes means for sending a notification of a new network address to the at least one other neighbor node in the neighbor table when the network address of the node changes.

In accordance with an embodiment of the present invention, there is provided a node including means for creating a neighbor table, configured to learn network identifiers and/or network addresses of neighbor nodes, means for storing the network identifiers and/or network addresses of neighbor nodes in the neighbor table, and means for receiving a notification of a new network address from the node at the at least one other neighbor node stored in the reverse finger table. The node also includes means for updating the neighbor table of the at least one other neighbor node with the new network address from the node.

In accordance with an embodiment of the present invention, there is provided a method including configuring a table to include a list of node identifiers of neighboring nodes and corresponding addresses, and configuring the list of node identifiers and the addresses independently from each other to update a change in at least one of the addresses associated with at least one of the neighboring nodes.

In accordance with an embodiment of the present invention, there is provided a method including creating a finger table at a node, subscribing to changes in a network address of at least one other node included in the finger table, and receiving at least one notification including an identifier and a network address of the at least one other node. The method also includes updating the finger table with a new network address of the at least one other node received in the at least one notification.

In accordance with an embodiment of the present invention, there is provided a method, including creating a reverse finger table at a node, receiving subscriptions to changes in network address of the node from at least one other node, and storing the network address of the at least one other node in the reverse finger table. The method also includes when the network address of the node changes, sending a notification of a new network address from the node to the at least one other node in the reverse finger table.

In accordance with an embodiment of the present invention, there is provided a method, including creating a neighbor table at a node, learning network identifiers and/or network addresses of neighbor nodes, and storing the network identifiers and/or network addresses of neighbor nodes in the neighbor table. The method also includes when the network address of the node changes, sending a notification of a new network address from the node to the at least one other neighbor node in the neighbor table.

In accordance with an embodiment of the present invention, there is provided a method, including creating a neighbor table at a node, learning network identifiers and/or network addresses of neighbor nodes, storing the network identifiers and/or network addresses of neighbor nodes in the neighbor table, and receiving a notification of a new network address from the node at the at least one other neighbor node stored in the neighbor table. The method also includes updating the neighbor table of the at least one other neighbor node with the new network address from the node.

### BRIEF DESCRIPTION OF THE DRAWINGS

Further embodiments, details, advantages and modifications of the present invention will become apparent from the following detailed description of the preferred embodiments which is to be taken in conjunction with the accompanying drawings, in which:

FIG. 1 illustrates a distributed hash table (DHT) ring and a neighbor table of one of the nodes in the DHT ring.

FIG. 2 illustrates the DHT ring and a finger table of one of the nodes in the DHT.

FIG. 3 illustrates a reverse finger table at a node in the DHT ring, in accordance with an embodiment of the present invention.

FIG. 4 illustrates a configuration in which a number of peers subscribe to a peer event state package of a peer, in accordance with an embodiment of the present invention.

FIG. 5 illustrates a configuration to notify peers after acquiring a new IP address by the peer, in accordance with an embodiment of the present invention.

FIG. 6 illustrates an alternative session initiation protocol mechanism to update reverse finger peers, in accordance with an embodiment of the present invention.

FIG. 7 illustrates a session initiation protocol mechanism to update neighboring peers after a change of IP address, in accordance with an embodiment of the present invention.

FIG. 8 illustrates a method in which nodes subscribe to a node event state package of a node, in accordance with an embodiment of the present invention.

FIG. 9 illustrates a method to configure a reverse finger table, in accordance with an embodiment of the present invention.

FIG. 10 illustrates a method to notify of neighboring nodes after acquiring a new address by the node, in accordance with an embodiment of the present invention.

FIG. 11 illustrates a method to receive a new address of a neighboring node and update a neighbor table, in accordance with an embodiment of the present invention.

### DETAILED DESCRIPTION OF THE PREFERRED EMBODIMENTS

Reference will now be made in detail to preferred embodiments of the present invention, examples of which are illustrated in the accompanying drawings.

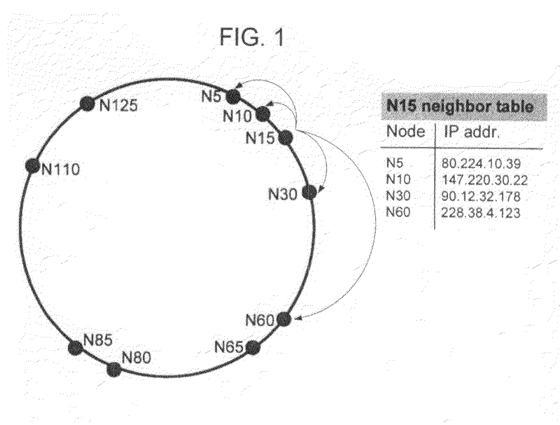

FIG. 1 illustrates a distributed hash table (DHT) ring and a neighbor table of a node (node 15, (N15)) in the DHT ring. Data stored in the DHT is indexed using data identifiers (IDs). The data IDs are distributed among the DHT nodes. Each DHT node stores a subset of the data IDs.

Depending on the arrangement of the DHT, each node in the DHT ring may have two direct neighbors: a predecessor peer and a successor peer. In some instances, in order to increase the reliability of the network, a peer may be linked to one, two, three, or more predecessors and/or one, two, three, or more successors. A position or place in the DHT ring may be determined using a peer identification (ID). The successor peer is a node whose peer ID may be defined as the next one in the DHT ring when moving clockwise (N30, N60, N65, etc.). The predecessor of a node may be defined as the next node in the DHT ring when moving counter-clockwise (N10 and N5). The number of predecessors and successors that the peer may be linked to may be kept to a short number. Each peer may keep track of its predecessor and successor by sending some type of keep-alive messages. For illustrative purposes, the node's predecessors and successors may be referred to collectively as neighbors. Each peer stores Internet protocol (IP) addresses (or/and other connectivity information) of their neighbors. This allows the node to contact its predecessors and successors.

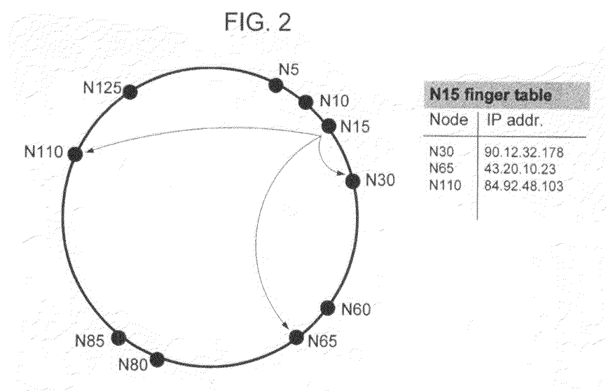

Additionally, each peer also maintains a routing table, sometimes called a finger table, which includes a list of peers and corresponding IP addresses (or/and other connectivity information) in the overlay DHT network (the number of peers in the list is typically much smaller than a number of peers in the overlay DHT network). FIG. 2 illustrates the DHT ring and a finger table of one of the nodes in the DHT. Essentially, the finger table is a type of collection of shortcuts to move throughout the DHT ring. Thus, the finger table may be used to minimize a number of hops needed to locate a resource in the overlay DHT network.

The structure of a DHT ring topology has to be maintained. This includes keeping track of predecessors, successors, its liveliness, and also keep an up-to-date finger table. To maintain the DHT ring, neighbors may send keep-alive messages to each other checking if a neighbor is still online. If a peer leaves a network the overlay network has to adapt to such changes. Such changes may include, for instance, a predecessor and successor of a peer become immediate neighbors; one of the neighbors become responsible for a pool of data IDs that a peer that left the DHT network was responsible for; if the overlay network uses a replication mechanism for data protection, the node that takes responsibility for the pool of data IDs that were stored in the node that left the network has to update its database storing data IDs and associated data; and/or the peers in the overlay that had a pointer to the peer that left the network in their finger tables should update their finger tables.

This introduces an additional traffic overhead between peers and requires additional processing power needed to modify information about neighbors and finger tables. When a peer joins the overlay network (for first time or after leaving a network) the overlay has to perform even more operations than in the case when a peer leaves a network. Additionally, updates to the DHT do not take place immediately after a node has gone. It may take some time until all the data is again in the proper place, including the re-creation of the finger table.

In one instance, a peer-to-peer session initiation protocol (P2PSIP) network may be based on DHT and two types of entities may exist. The first entity would be a peer(s), which would maintain a P2PSIP overlay network by running a DHT protocol and store user data (for instance, contact information: session initiation protocol (SIP) to Internet protocol (IP) mapping), which in principle would provide a PUT method and a GET method. The PUT method would allow storing of data in the overlay DHT network. The GET method would allow data retrieval from the overlay DHT network. The second entity would be a client(s), which connect to peers and allow users to put/get information to/from the overlay network. SIP user agent (UA) may be collocated with a peer or a client. Among others the peers may also be collocated with (act as) SIP proxies, media relays and NAT traversal servers.

In one instance, P2PSIP data stored in the overlay network may represent SIP registration data, such as SIP uniform resource identifier (URI) to IP address binding. Data ID is a hashed SIP URI. In P2PSIP, user's reachability data stored in the DHT is much more critical (particular to timing variances) than the content stored in the DHT of file sharing networks because the P2PSIP data has to be available all of the time and be accessible in real time.

Therefore, in a network, such as a P2PSIP network, in which it is of utmost importance that the data is accurate, requires that changes to the data or the DHT ring structure (such as when a peer leaves the DHT) are propagated in real-time to the rest of the peers that need that information.

Mobile terminal or any other similar type of mobile device, for instance, moves from one network to another by doing handovers between different access networks or moving from one WLAN access point to another, which may cause network instability and require additional resources to handle network adaptation. Such network adaptation need may also impact the battery life of the mobile terminal and system reliability. In the transition period search delay for user contact information may be significantly higher, thereby delaying call establishment.

Accordingly, a node and method are provided in accordance with various embodiments of the present invention in which peer-to-peer node identifiers are allocated independently from associated Internet Protocol (IP) addresses for each peer or node in a network, such as a distributed hash table (DHT) network.

In accordance with an embodiment of the present invention, a node and method are provided in which a first peer configures a finger table to include identifiers of at least one or more peers and corresponding addresses. The first peer outputs notifications to each of the one or more peers. Each notification includes an identifier of the first peer and a corresponding address. A second peer associated with one of the addresses and, in response to receiving a notification from the first peer, is configured to define a reverse finger table to include the identifier of the first peer and the corresponding address.

In accordance with another embodiment of the present invention, a node and method are provided in which a peer is configured to define a finger table to include an identifier of at least one peer and a corresponding address and configured to output notifications to the at least one peer. Each notification includes an identifier of the peer and a corresponding address. A peer associated with one of the addresses, in response to receiving a notification from the peer, is configured to determine whether the address of the peer matches an address pre-defined in the reverse finger table stored therein and corresponding to the identifier of the peer, and configured to update the address of the peer when the address associated with the identified peer is not a match with the address pre-defined in the reverse table. In response to receiving the notification, the peer may be further configured to identify and authenticate the peer.

Accordingly, some embodiments of the present invention address mobility aspects in P2PSIP. For instance, mobile terminals may act as P2PSIP peers, which have intermittent connectivity and multiple access network capabilities.

Whenever a peer changes its access network (e.g., from WCDMA to WLAN), its IP address also changes. Because of this, its peer ID changes as well, provoking instability in the DHT ring. According to one aspect of this invention, peer IDs may be statically allocated and its allocation is not dependent on the corresponding peer IP address. Rather than creating the peer ID by hashing the corresponding IP address, which is no longer static for the duration of the connection to the DHT, in accordance with an embodiment of the present invention, statically allocated unique (within a DHT ring) peer IDs are configured. The IP address may also change due to reasons other than changing access network, such as, for example, if the node obtains a new address from DHCP.

When a mobile device associated with a peer moves to another subnet or access network after a handover, the peer receives a new IP address for the mobile device. In accordance with an aspect of the invention, because the peer ID is configured not to change, the peer ID would not provoke instability to the DHT ring. However, the peer would need to inform the neighboring peers about a new IP address associated with the other subnet. To each neighbor, the peer would transmit the existing peer ID, the new IP address, and, if so configured, authentication data (for example, a certificate). Each neighbor, in turn, would authenticate the update request and store the new IP address bound to that peer ID. If the peer informs the neighbors before a keepalive interval or a predetermined time interval expires, there is no need to execute a reconfiguration of the DHT network. Each peer would inform each neighboring peer about changes to their IP address. The keepalive interval or the predetermined time interval may be defined during initialization and may be configured based on a particular application, or it may adapt to a chum rate of the DHT in which case unnecessary keepalive messages may be eliminated.

According to another aspect of this invention, a peer may inform other peers that store pointers to this peer in their respective finger tables about the changes to the peer's IP address. This operation reduces the search delay because the connectivity information stored in the finger tables is kept up to date.

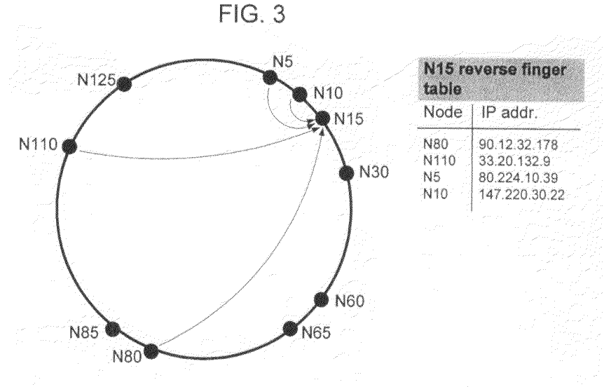

FIG. 3 illustrates a reverse finger table at a node in the DHT ring, in accordance with an embodiment of the present invention. When a first peer is creating its finger table, the peer would select a number of peers and insert their node IDs and IP addresses into the first peer's finger table. In accordance with an embodiment of the present invention, this process may be extended so that the first peer (N15) may notify those selected nodes or peers (N80, N110, N5, and N10) that they have been inserted into N15 finger table. On doing so, each notified peer (N80, N110, N5, and N10) creates a reverse finger table of nodes that are storing information about the peer as illustrated in FIG. 3. If any of the notified peers (N80, N110, N5, and N10) changes its IP address at some point in time; the selected peer will notify the first peer and other peers that are listed in its reverse finger table, so that they can update their respective finger tables. In accordance with an embodiment of the present invention, the creation of the reverse finger table at the first peer or at any of the selected peers may be executed in the background, at a lower priority, or when the network is less congested.

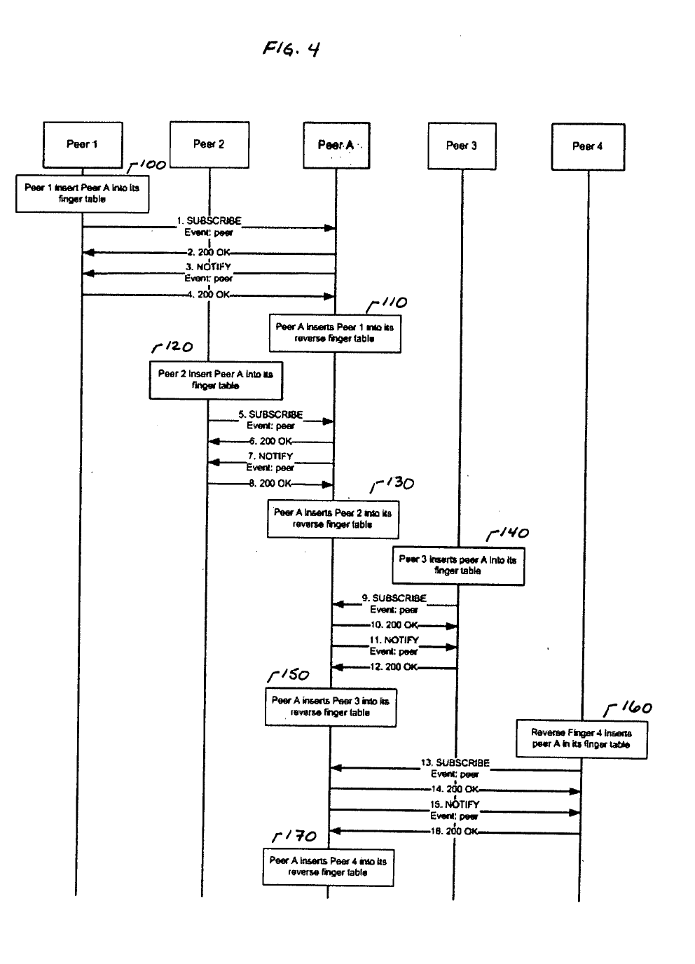

FIG. 4 illustrates a configuration in which a number of peers subscribe to a peer event state package of a peer, in accordance with an embodiment of the present invention. Several peers or nodes are building their corresponding finger tables. As shown in step 100, Peer 1 is configuring its own finger table. Peer 1 inserts an ID and corresponding IP address of Peer A into its finger table and sends an indication to Peer A, which can be realized in one embodiment with a subscription with the Session Initiation Protocol.

The infrastructure of the Session Initiation Protocol (SIP) is defined in Internet Engineering Task Force (IETF) RFC3261 (Rosenberg et al., June 2002). In general, the SIP is an application-layer control (signaling) protocol for creating, modifying and terminating sessions with one or more participants. The sessions can include Internet telephone calls, multimedia distribution and multimedia conferences. SIP invitations used to create sessions carry session descriptions that allow the nodes to agree on a set of compatible media types. In “SIP-Specific Event Notification,” A. Roach, RFC 3265, July 2002 (referred to hereafter simply as “RFC 3265”), there is described a SIP event framework to enable event-based information provisioning to any peer or node in the Internet. Examples of this kind of information are presence, location information, content/service availability, or access-controlled SIP events.

As is discussed in RFC 3265, the general concept is that entities in the network can subscribe to resource or call state for various resources or calls in the network, and those entities (or entities acting on their behalf) can send notifications when those states change. A typical flow of messages between Peer A and Peer 1 is illustrated in steps 1-4 of FIG. 4.

In steps 1-4, compliant with RFC 3265 the subscriber or Peer 1 sends a SIP SUBSCRIBE request to Peer A. The SUBSCRIBE message header includes an appropriate event package identifier for a discovery event package. Upon reception of the subscription message, Peer A extracts the message body and parses the included semantic information of the discovery query. If the discovery query can be supported by Peer A (that is, the semantic is supported locally, or if an appropriate context query server is available to fulfill the request), Peer A confirms the subscription with a ‘200 OK’ message and sends a NOTIFY message, compliant with RFC 3265. Peer 1 would confirm that it received the NOTIFY message by sending back ‘200 OK’ message, compliant with RFC 3265. As illustrated in FIG. 4, similar steps are performed between Peer A and Peer 2 (steps 5-8), Peer 3 (steps 9-12), and Peer 4 (steps 13-16) as those described with respect to Peer 1. Accordingly, the descriptions of the steps performed between steps 1-4 are incorporated herein for steps 5-16. In an alternative implementation, rather than using the SIP event notification framework (SUBSCRIBE/NOTIFY), SIP PUBLISH request (RFC 3903) may be used, which does not require a previous subscription, for updating the peer details.

Upon reception of the indication or subscription at Peer A, at step 110, Peer A would configure a reverse finger table by including at least the ID and corresponding IP address of Peer 1. A person of ordinary skill in the art will appreciate that the IDs and IP addresses of other peers may be selectively included in the reverse finger table of Peer A. Selectively is intended to be defined as each peer being able to configure their associated table to include the IDs and IP addresses of either all the peers in the overlay or less.

As shown in step 120, Peer 2 is configuring its own finger table. Peer 2 inserts an ID and corresponding IP address of Peer A into its finger table and sends an indication to Peer A, which can be realized in one embodiment with a subscription with the Session Initiation Protocol. Upon reception of this indication or subscription at Peer A, at step 130, Peer A would configure a reverse finger table by including at least the ID and corresponding IP address of Peer 2. As shown in step 140, Peer 3 is configuring its own finger table. Peer 3 inserts an ID and corresponding IP address of Peer A into its finger table and sends an indication to Peer A, which can be realized in one embodiment with a subscription with the Session Initiation Protocol. Upon reception of this indication or subscription at Peer A, at step 150, Peer A would configure a reverse finger table by including at least the ID and corresponding IP address of Peer 3.

As shown in step 160, Peer 4 is configuring its own finger table. Peer 4 inserts an ID and corresponding IP address of Peer A into its finger table and sends an indication to Peer A, which can be realized in one embodiment with a subscription with the Session Initiation Protocol. Upon reception of this indication or subscription at Peer A, at step 170, Peer A would configure a reverse finger table by including at least the ID and corresponding IP address of Peer 4.

A person of ordinary skill in the art will appreciate that the IDs and IP addresses of other peers may be selectively included in the Peer 1, Peer 2, Peer 3, and/or Peer 4. Accordingly, as illustrated in FIG. 4, when a first peer is building its finger table and inserts the peer ID of a second peer in a first peer finger table, the first peer notifies the second peer, so that the second peer may also build a reverse finger table by inserting the peer ID and IP address of the first peer in the second peer reverse finger table. This may be implemented with any type of protocol framework, which may be extended with an appropriate event package (such as, peer event package). The event package defines, among other things, the data format used by the SIP event notifications. In this case, the peer event package contains information of the peer ID, IP address or URI, and/or authentication data.

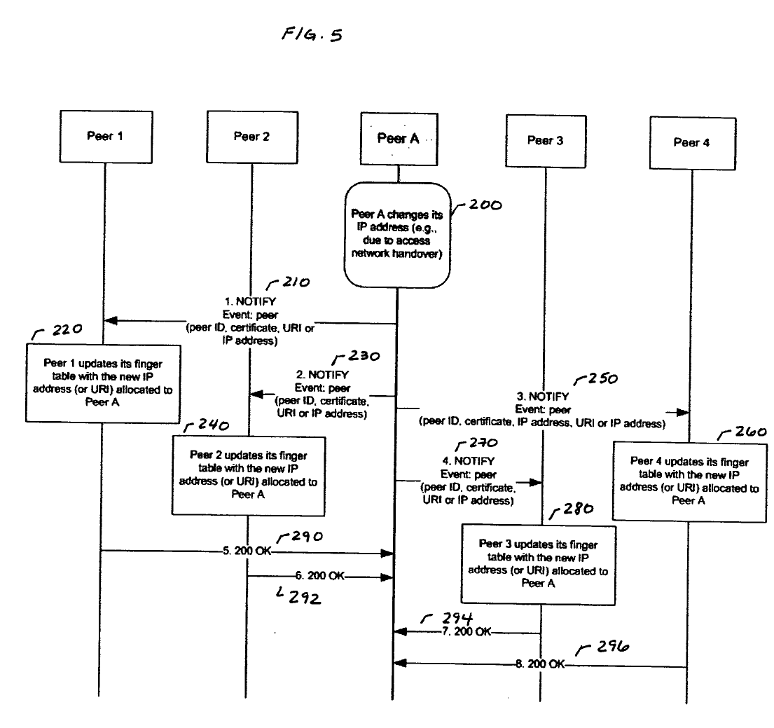

FIG. 5 illustrates a configuration to notify peers after acquiring a new IP address, in accordance with an embodiment of the present invention. According to an aspect of the invention, when a peer changes its IP address, it informs each of the subscribers. The notification may include the peer ID, the new IP address (or a URI that resolves to that IP address), and authentication data (such as a certificate).

At step 200, Peer A moves from one network to another by doing handover between different access networks or moving from one WLAN access point to another, thereby changing the IP address or URI associated thereto and obtaining a new IP address or URI, or it may obtain a new IP address for another reason. At step 210, a notification is performed in compliance with any established protocol. In an alternative implementation, rather than using the SIP event notification framework (SUBSCRIBE/NOTIFY), SIP PUBLISH request may be used, which does not require a previous subscription, for updating the peer details. Peer A transmits a notification to Peer 1 including, amongst other information, if so configured, Peer A's ID, authentication data (such as a certificate) and the new IP address. At step 220, Peer 1 authenticates Peer A using Peer A's ID and authentication data (such as a certificate), thereby confirming that Peer A is registered in the table of Peer 1. Peer 1 then updates its table with the new IP address of Peer A (or URI).

At step 230, similarly to step 210, a notification is performed in compliance with any established protocol. Peer A transmits a notification to Peer 2 including, amongst other information, if so configured, Peer A's ID, authentication data (such as a certificate) and the new IP address. At step 240, Peer 2 authenticates Peer A using Peer A's ID and authentication data (such as a certificate), thereby confirming that Peer A is registered in the table of Peer 2. Peer 2 then updates its table with the new IP address of Peer A (or URI).

Although the notification of the change in the IP address of Peer A may be performed sequentially for each associated peer, a person of ordinary skill in the art may appreciate that Peer A could be configured to simultaneously notify all the associated peers of the change or may notify in a random manner all the associated peers of the change.

For instance, rather than continuing to update Peer 3, in the embodiment described in FIG. 5, after updating the table in the Peer 2, Peer A continues by updating the table of Peer 4. At step 250, similarly to step 210, a notification is performed in compliance with an established protocol. Peer A transmits a notification to Peer 4 including, amongst other information, if so configured, Peer A's ID, authentication data (such as a certificate) and the new IP address. At step 260, Peer 4 authenticates Peer A using Peer A's ID and authentication data (such as a certificate), thereby confirming that Peer A is registered in the table of the Peer 4. Peer 4 then updates its table with the new IP address of Peer A (or URI).

At step 270, similarly to step 210, a notification is performed in compliance with established practice. Peer A transmits a notification to Peer 3 including, amongst other information, if so configured, Peer A's ID, authentication data (such as a certificate) and the new Peer A's IP address. At step 280, Peer 3 authenticates Peer A using Peer A's ID and authentication data (such as a certificate), thereby confirming that Peer A is registered in the table of Peer 3. Peer 3 then updates its table with the new IP address of Peer A (or URI). Steps 290-296 may be performed in compliance with any established protocol, where each peer in Peer A's reverse finger table would transmit a ‘200 OK’ to Peer A.

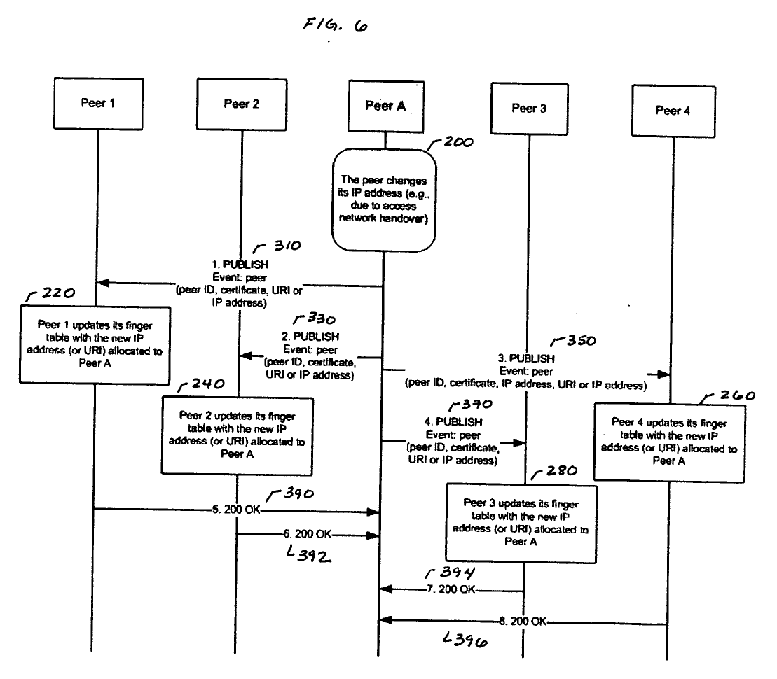

FIG. 6 illustrates an alternative session initiation protocol mechanism or method thereof to update peers, in accordance with an embodiment of the present invention. The protocol can invite participants to unicast or multicast sessions that do not necessarily involve the initiator. Because the SIP supports name mapping and redirection services, it makes it possible for users to initiate and receive communications and services from any location, and for networks to identify the users wherever they are. SIP is a request-response protocol, dealing with requests from clients and responses from servers. Participants are identified by SIP URLs. Requests can be sent through any transport protocol, such as User Datagram Protocol (UDP), Simple Control Transport Protocol (SCTP), or transmission control protocol (TCP). SIP determines the end system to be used for the session, the communication media and media parameters, and the called party's desire to engage in the communication. Once these are assured, SIP establishes call parameters at either end of the communication, and handles call transfer and termination. Accordingly, FIG. 6 shows the implementation of an alternative to the mechanism described in FIG. 5. Instead of using NOTIFY request (that are build upon a subscription), this alternative uses PUBLISH requests that are sent to the nodes in the reverse finger table. The information being exchanged in steps 310, 330, 350, 370, and 390-396 are the same as that of the NOTIFY requests in steps 210, 230, 250, 270, and 290-296 of FIG. 5, which is incorporated herein. Similarly, steps 200, 220, 240, 260, and 280 described in FIG. 5 are the same for FIG. 6, accordingly, their description are incorporated herein.

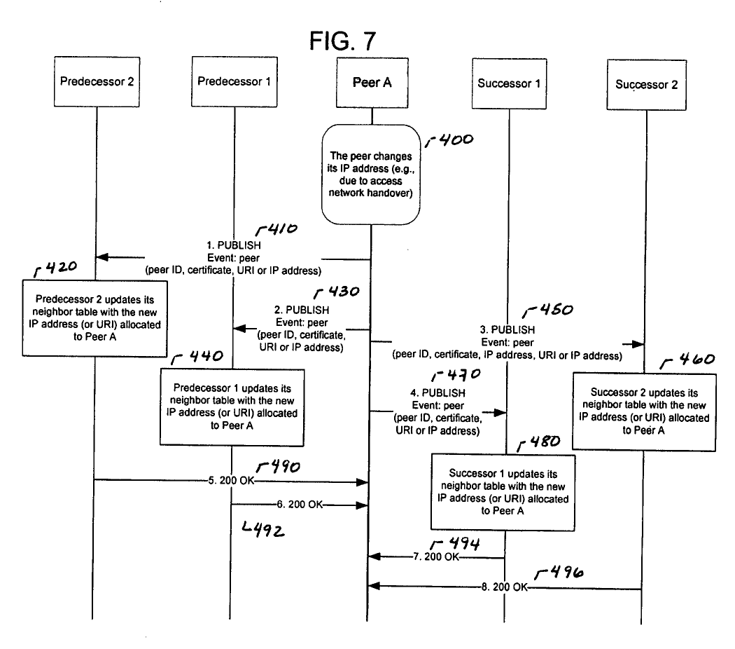

According to another aspect of the invention, a mechanism for updating the neighbor tables of a peer's neighbor is also provided. Such mechanism may be implemented with a SIP PUBLISH request. A person of ordinary skill in the art will appreciate that any other type of protocol such as SIP or HTTP protocol could be used instead of SIP PUBLISH. If implementing a SIP protocol, a SIP request may contain the peer ID, the corresponding new IP address (or a URI that resolves to that IP address), and authentication data (such as a certificate). FIG. 7 illustrates a session initiation protocol mechanism or method thereof to update neighboring peers after a change of IP address, in accordance with an embodiment of the present invention. FIG. 7 illustrates an update procedure that may use SIP PUBLISH request without a need of any subscriptions, in accordance with an embodiment of the present invention. An alternative method could use subscriptions (SUBSCRIBE/NOTIFY).

At step 400, Peer A moves from one network to another by doing handover between different access networks or moving from one WLAN access point to another, thereby changing the IP address or URI associated thereto, thereby obtaining a new IP address or URI. At step 410, a SIP PUBLISH request message, which does not require a previous subscription for updating the peer details, is sent to Predecessor 2. In an alternative implementation, rather than using SIP PUBLISH, the SIP event notification framework (SUBSCRIBE/NOTIFY) (RFC 3265) may be used. Peer A transmits a notification to Predecessor 2 including, amongst other information, Peer A's ID, authentication data (such as a certificate) and the new IP address. At step 420, Predecessor 2 authenticates Peer A using Peer A's ID and authentication data (such as a certificate), thereby confirming that Peer A is registered in the neighbor table of Predecessor 2. Predecessor 2 then updates its neighbor table with the new IP address of Peer A (or URI).

At step 430, similarly to step 410, a notification is performed in compliance with any established protocol. Peer A transmits a notification to Predecessor 1 including, amongst other information, Peer A's ID, authentication data (such as a certificate) and the new IP address. At step 440, Predecessor 1 authenticates Peer A using Peer A's ID and authentication data (such as a certificate), thereby confirming that Peer A is registered in the neighbor table of Predecessor 1. Predecessor 1 then updates its neighbor table with the new IP address of Peer A (or URI).

After updating the table in Predecessor 1, Peer A continues by updating the neighbor table of Successor 2. At step 450, similarly to step 410, a notification is performed in compliance with any established protocol. Peer A transmits a notification to Successor 2 including, amongst other information, Peer A's ID, authentication data (such as a certificate) and the new IP address. At step 460, Successor 2 authenticates Peer A using Peer A's ID and authentication data (such as a certificate), thereby confirming that Peer A is registered in the table of Successor 2. Successor 2 then updates its table with the new IP address of Peer A (or URI). Here and elsewhere in the context of this application, authentication and/or other security features are optional embodiments and practicing the present invention is not restricted to embodiments comprising such features.

At step 470, similarly to step 410, a notification is performed in compliance with an established protocol. Peer A transmits a notification to Successor 1 including, amongst other information, Peer A's ID, authentication data (such as a certificate) and the new IP address. At step 480, Successor 1 authenticates Peer A using Peer A's ID and authentication data (such as a certificate), thereby confirming that Peer A is registered in the table of Successor 1. Successor 1 then updates its table with the new IP address of Peer A (or URI). Steps 490-496 may be performed in compliance with an established protocol, where each neighboring peer would transmit a ‘200 OK’ to Peer A.

Although the notification of the change in the IP address of Peer A may be performed sequentially for each associated neighboring peer, a person of ordinary skill in the art may appreciate that Peer A could be configured to simultaneously notify all the associated predecessors or successors of the change or may notify in a random manner all the associated neighboring peers of the change.

Accordingly, as illustrated in FIG. 7, after a change of IP address in Peer A, the node informs its neighbors of its new IP address. It does so by sending a SIP PUBLISH request message to each neighbor. The PUBLISH request includes a body that contains the notifier's peer ID, the new IP address or URI that resolves to that IP address, and authentication data. Upon reception of this PUBLISH request, the neighbor authenticates the peer combination (with a certificate), and updates its neighbor table with the new updated information.

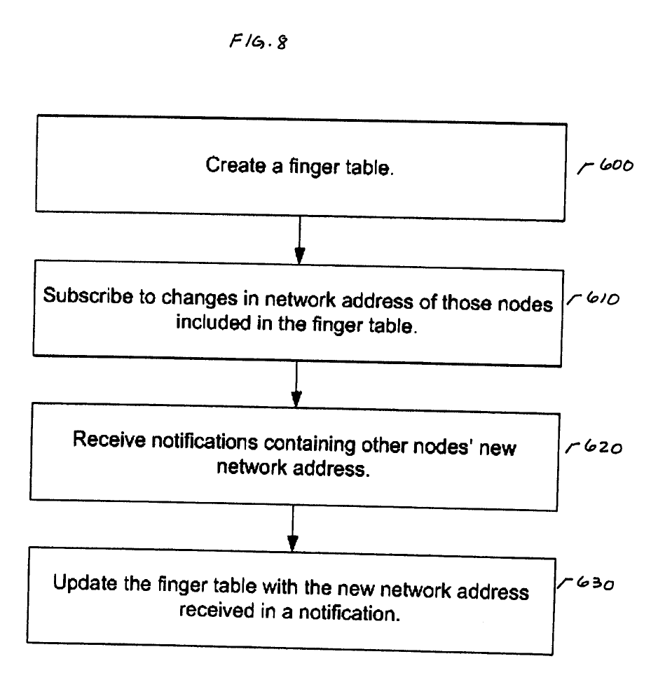

FIG. 8 illustrates a method in which nodes subscribe to a node event state package of a node, in accordance with an embodiment of the present invention. At step 600, the method includes creating a finger table in a node. At step 610, the method subscribes to changes in a network address of at least one other node included in the finger table. At step 620, the method receives at the node at least one notification including an identifier and a network address of the at least one other node. At step 630, the method updates the finger table with a new network address of the at least one other node received in the notification.

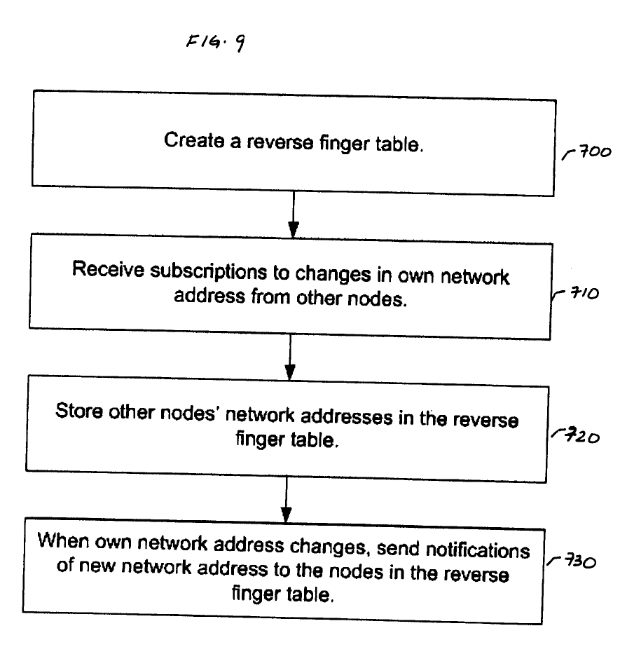

FIG. 9 illustrates a method to configure a reverse finger table, in accordance with an embodiment of the present invention. At step 700, the method creates a reverse finger table at a node. At step 710, the method receives subscriptions to changes in own network address from at least one other node. At step 720, the method stores the network address of the at least one other node in the reverse finger table. At step 730, when the network address, or other corresponding connectivity information, of the node changes, the method sends a notification of a new network address from the node to the at least one other node stored in the reverse finger table.

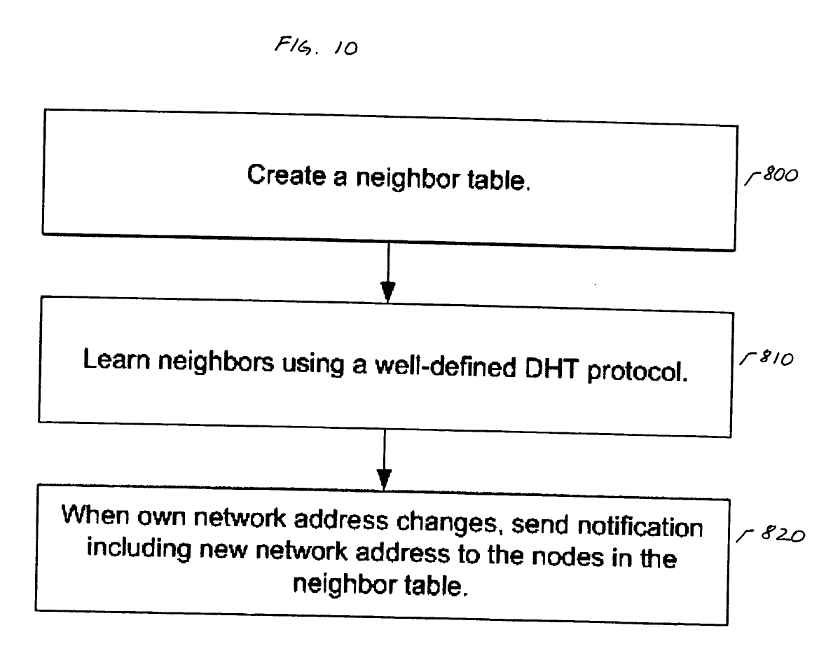

FIG. 10 illustrates a method to notify of neighboring nodes after acquiring a new address by the node, in accordance with an embodiment of the present invention. At step 800, the method creates a neighbor table at a node. At step 810, the method learns network identifiers and/or network addresses of neighbor nodes using, for instance, a well-defined DHT protocol. At step 820, when the network address of the node changes, the method sends a notification of a new network address from the node to the at least one other neighbor node stored in the neighbor table.

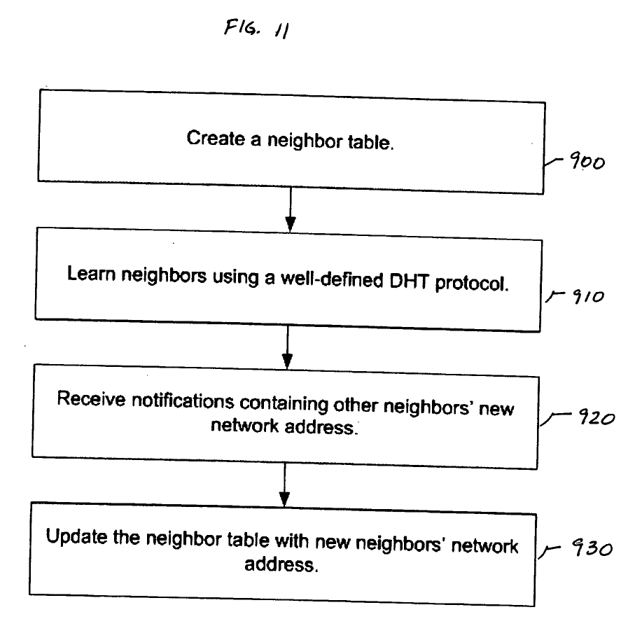

FIG. 11 illustrates a method to receive a new address of a neighboring node and update a neighbor table, in accordance with an embodiment of the present invention. At step 900, the method creates a neighbor table at a node. At step 910, the method learns network identifiers and/or network addresses of neighbor nodes using, for instance, a well-defined DHT protocol. At step 920, the method receives a notification of a new network address from the node to the at least one other neighbor node stored in the neighbor table. At step 930, the method updates the neighbor table of the at least one other neighbor node with the new network address from the node.

Some of the many advantages of the present invention include minimizing overlay network instability, minimizing overhead traffic and usage of resources, for instance, battery power, required to handle network reconfiguration, and reducing a search delay in the case of network chum, such as peers joining and/or leaving the overlay DHT network.

In view of the foregoing, in accordance with various embodiments of the present invention, there is provided a node and method configuring, providing, and maintaining real-time up-to-date peer identification and Internet protocol address mapping information in peer nodes of a distributed hash table network architecture.

It is to be understood that in the embodiment of the present invention, the steps are performed in the sequence and manner as shown although the order of some steps and the like may be changed without departing from the spirit and scope of the present invention. In addition, the methods described in FIGS. 4-9 may be repeated as many times as needed.

In accordance with an embodiment of the present invention, a computer program product embodied on a computer-readable medium may also be provided, encoding instructions for performing at least the method described in FIGS. 4-9, in accordance with an embodiment of the present invention. The computer program product can be embodied on a computer readable medium. The computer program product can include encoded instructions for processing the tunneling transmission for a wireless multihop wireless system, which may also be stored on the computer readable medium.

The computer program product can be implemented in hardware, software, or a hybrid implementation. The computer program product can be composed of modules that are in operative communication with one another, and which are designed to pass information or instructions to a communications device such as a user equipment or network node. The computer program product can be configured to operate on a general purpose computer or an application specific integrated circuit (ASIC).

In accordance with an embodiment of the present invention, a device communicating with a node or peer may include any type of mobile or non-mobile network element including, but not limited to, a mobile station, a laptop, a user equipment, a wireless transmit/receive unit, a fixed or mobile subscriber unit, a mobile telephone, a computer (fixed or portable), a pager, a personal data assistant or organizer, or any other type of network element capable of operating in a wireless environment or having networking capabilities. For instance, if the device is a laptop, when the laptop is switched on, scans for available networks and their supported services (including location configuration protocol). The laptop can then have a profile listing the criteria for the selection from the available networks. The laptop can automatically select the network which matches better with the profile. Once the laptop has to move, it may be switched off and then again on at the new location, where the method described herein is repeated.

In addition, while the term data has been used in the description of the present invention, the invention has import to many types of network data. For purposes of this invention, the term data includes packet, cell, frame, datagram, bridge protocol data unit packet, packet data and any equivalents thereof.

The many features and advantages of the invention are apparent from the detailed specification and, thus, it is intended by the appended claims to cover all such features and advantages of the invention which fall within the true spirit and scope of the invention. Further, since numerous modifications and changes will readily occur to those skilled in the art, it is not desired to limit the invention to the exact construction and step illustrated and described, and accordingly all suitable modifications and equivalents may be resorted to, falling within the scope of the invention.

What is claimed:

1. A node, comprising:
a table comprising a list of node identifiers of neighboring nodes and corresponding addresses, wherein the list of node identifiers and the addresses are configured independently from each other to update a change in at least one of the addresses associated with at least one of the neighboring nodes.

2. The node as recited in claim 1, wherein the table comprises at least one node identifier and corresponding address of a node in a network that is not a neighboring node.

3. The node as recited in claim 1, wherein the addresses comprise Internet protocol addresses or uniform resource identifiers.

4. A node configured to create a finger table, configured to subscribe to changes in a network address of at least one other node included in the finger table, configured to receive at least one notification including an identifier and a network address of the at least one other node, and configured to update the finger table with the new network address of the at least one other node received in the at least one notification.

5. The node as recited in claim 4, wherein the finger table comprises an identifier and a corresponding address of at least one node not neighboring the node.

6. The node as recited in claim 4, wherein the node notifies all nodes that store pointers to the node in reverse tables that the address of the node has changed.

7. The node as recited in claim 4, wherein the at least one notification comprises a session initiation protocol event notification framework or a session initiation protocol publication request.

8. The node as recited in claim 4, wherein the at least one notification further comprises authentication data to authenticate the at least one node transmitting the notification.

9. The node as recited in claim 4, wherein the at least one node is a neighboring node, a successor, or a predecessor to the node.

10. A node configured to create a reverse finger table, configured to receive subscriptions to changes in a network address of the node from at least one other node, configured to store the network address of the at least one other node in the reverse finger table, and configured to send a notification of a new network address from the node to the at least one other node in the reverse finger table when the network address of the node changes.

11. The node as recited in claim 10, wherein the reverse finger table comprises an identifier and a corresponding address of at least one node not neighboring the node.

12. The node as recited in claim 10, wherein the node notifies all nodes that store pointers to the node that the address of the node has changed.

13. The node as recited in claim 10, wherein the notification comprises a session initiation protocol event notification framework or a session initiation protocol publication request.

14. The node as recited in claim 10, wherein the notification further comprises authentication data to authenticate the node at least one other node.

15. The node as recited in claim 10, wherein the node is a neighboring node, a successor, or a predecessor to the at least one node.

16. A node configured to create a neighbor table, configured to learn network identifiers and/or network addresses of neighbor nodes, configured to store the network identifiers and/or network addresses of neighbor nodes in the neighbor table, and configured to send a notification of a new network address to the at least one other neighbor node in the neighbor table when the network address of the node changes.

17. A node configured to create a neighbor table, configured to learn network identifiers and/or network addresses of neighbor nodes, configured to store the network identifiers and/or network addresses of neighbor nodes in the neighbor table, configured to receive a notification of a new network address from the node at the at least one other neighbor node stored in the reverse finger table, and configured to update the neighbor table of the at least one other neighbor node with the new network address from the node.

18. A node, comprising:
means for creating a finger table;
means for subscribing to changes in a network address of at least one other node included in the finger table;
means for receiving at least one notification including an identifier and a network address of the at least one other node; and
means for updating the finger table with the new network address of the at least one other node received in the at least one notification.

19. A node, comprising:
means for creating a reverse finger table;
means for receiving subscriptions to changes in a network address of the node from at least one other node;
means for storing the network address of the at least one other node in the reverse finger table; and
means for sending a notification of a new network address from the node to the at least one other node in the reverse finger table when the network address of the node changes.

20. A node, comprising:
means for creating a neighbor table;
means for learning network identifiers and/or network addresses of neighbor nodes;
means for storing the network identifiers and/or network addresses of neighbor nodes in the neighbor table; and
means for sending a notification of a new network address to the at least one other neighbor node in the neighbor table when the network address of the node changes.

21. A node comprising:
means for creating a neighbor table, configured to learn network identifiers and/or network addresses of neighbor nodes;
means for storing the network identifiers and/or network addresses of neighbor nodes in the neighbor table;
means for receiving a notification of a new network address from the node at the at least one other neighbor node stored in the neighbor table; and
means for updating the neighbor table of the at least one other neighbor node with the new network address from the node.

22. A method, comprising:
configuring a table to comprise a list of node identifiers of neighboring nodes and corresponding addresses; and
configuring the list of node identifiers and the addresses independently from each other to update a change in at least one of the addresses associated with at least one of the neighboring nodes.

23. The method as recited in claim 22, further comprising:
configuring the table to comprise at least one node identifier and corresponding address of a node in a network that is not a neighboring node.

24. The method as recited in claim 22, further comprising:
configuring the addresses to comprise Internet protocol addresses or uniform resource identifiers.

25. A method, comprising:
creating a finger table at a node;
subscribing to changes in a network address of at least one other node included in the finger table;
receiving at least one notification including an identifier and a network address of the at least one other node; and
updating the finger table with a new network address of the at least one other node received in the at least one notification.

26. The method as recited in claim 25, further comprises:
configuring the finger table to comprise an identifier and a corresponding address of at least one node not neighboring the node.

27. The method as recited in claim 25, further comprising:
notifying all nodes that store pointers to the node in reverse tables that the address of the node has changed.

28. The method as recited in claim 25, further comprising:
configuring the at least one notification to comprise a session initiation protocol event notification framework or a session initiation protocol publication request.

29. The method as recited in claim 25, further comprising:
configuring the at least one notification to further comprise authentication data to authenticate the at least one node transmitting the notification.

30. The method as recited in claim 25, further comprising:
outputting using the node the notifications to each of the neighboring nodes during a time interval.

31. A method, comprising:
creating a reverse finger table at a node;
receiving subscriptions to changes in a network address of the node from at least one other node;
storing the network address of the at least one other node in the reverse finger table; and
when the network address of the node changes, sending a notification of a new network address from the node to the at least one other node in the reverse finger table.

32. The method as recited in claim 31, further comprising:
configuring the reverse finger table to comprise an identifier and a corresponding address of at least one node not neighboring the node.

33. The method as recited in claim 31, further comprising:
notifying all nodes that store pointers to the node that the address of the node has changed.

34. The method as recited in claim 31, further comprising:
configuring the notification to comprise a session initiation protocol event notification framework or a session initiation protocol publication request.

35. The method as recited in claim 31, further comprising:
configuring the notification to further comprise authentication data to authenticate the node at least one other node.

36. A method, comprising:
creating a neighbor table at a node;
learning network identifiers and/or network addresses of neighbor nodes;
storing the network identifiers and/or network addresses of neighbor nodes in the neighbor table; and
when the network address of the node changes, sending a notification of a new network address from the node to the at least one other neighbor node in the neighbor table.

37. A method, comprising:
creating a neighbor table at a node;
learning network identifiers and/or network addresses of neighbor nodes;
storing the network identifiers and/or network addresses of neighbor nodes in the neighbor table;
receiving a notification of a new network address from the node at the at least one other neighbor node stored in the neighbor table; and
updating the neighbor table of the at least one other neighbor node with the new network address from the node.
